(19) United States
(12) Patent Application Publication
(10) Pub. No.: US 2007/0046036 A1
(43) Pub. Date: Mar. 1, 2007

(54) Slidable and rotatable lock for a window or door

(76) Inventor: Bruce F. Kinsey, Beaufort, SC (US)

Correspondence Address: SIMPSON & SIMPSON, PLLC, 5555 MAIN STREET, WILLIAMSVILLE, NY, 14221-5406, US

(21) Appl. No.: 11/508,342

(22) Filed: Aug. 23, 2006

Related U.S. Application Data
(60) Provisional application No. 60/713,404, filed on Sep. 1, 2005.

(51) Int. Cl. E05C 3/14

(52) U.S. Cl. 292/228

(57) ABSTRACT

The invention broadly comprises an automatic locking assembly, including a rotatable cam arranged to at least indirectly connect to a first component of a sliding access control device and at least one resilient element arranged to urge the cam in a first direction at least partially orthogonal to a plane formed between the components. An axis of rotation for the cam is arranged to displace in the first direction, and the cam is rotatable independent of the displacement. In a locked position, the axis is arranged to displace in the first direction. When the cam is rotated to an unlocked position, the axis is arranged to displace in a second direction at least partially opposite the first direction. The displacement in the first and second directions is with respect to the first component. In some aspects, the cam locks device components or displaces a slide element to lock the components.

### CROSS-REFERENCE TO RELATED APPLICATIONS

This application claims the benefit under 35 U.S.C. §119(e) of U.S. Provisional Application No. 60/713,404, filed Sep. 1, 2005.

### FIELD OF THE INVENTION

The invention relates generally to window or door locks. In particular, the invention relates to a lock for a sliding window or door that automatically assumes a locked position when the sliding components of the window or door are fully closed with respect to each other. Further, the lock enables a user to move the sliding components with minimal manipulation of the lock.

### BACKGROUND OF THE INVENTION

There is a well-known demand from window and hardware manufacturers for hardware that automatically locks when a window or door, for example, a double hung window, is closed. A number of these devices are already on the market. Unfortunately, most of these locks use complicated secondary mechanical actions to allow the lock to be held in the open position while the sash is opened, but then move to a latched position when the sash is closed. Another design requires the operator to hold the latch in the un-locked position while raising the sash.

Thus, there is a long-felt need to provide an automatic lock for a window or door with a simple design and requiring minimal intervention from a user.

### SUMMARY OF THE INVENTION

The invention broadly comprises an automatic locking assembly, including: a rotatable cam, with a protrusion, arranged to at least indirectly connect to a first component of a sliding access control device and at least one resilient element arranged to urge the cam in a first direction at least partially orthogonal to a plane formed between the first and second components. An axis of rotation for the cam is arranged to displace in the first direction, the displacement with respect to the first component, and the cam is rotatable independent of the displacement. In a locked position, the axis is arranged to displace in the first direction. When the cam is rotated to an unlocked position, the axis is arranged to displace in a second direction at least partially opposite the first direction, the displacement in the second direction with respect to the first component. In some aspects, the cam is arranged to lock the first component and a second component of the sliding access control device or to displace a slide element to lock the components.

In some aspects, the locking assembly includes a latch assembly associated with the second component and when rotated to the unlocked position the protrusion is arranged to engage a portion of the first latch element to displace the cam. In some aspects, the at least one resilient element is arranged to urge the cam in a rotational direction and when rotated to the unlocked position the protrusion is arranged to engage a portion of the latch element to prevent rotation in the rotational direction. In some aspects, the sliding access control device is selected from the group consisting of a sliding window and a sliding door and the first and second components are selected from the group consisting of a window sash and a door panel. In some aspects, the latching element is separate from the second component or the latching element is integral to the second component.

The invention also broadly comprises an automatic window locking assembly, with a housing arranged for attachment to a first sash of a sliding window; a cam, with a protrusion, at least partially disposed in the housing; a latch element associated with a second sash of the window; and at least one resilient element arranged to urge the cam in a first rotational direction and in a first direction at least partially orthogonal to a plane formed between the first and second sashes. When rotated to an unlocked position the cam is arranged so that the protrusion engages a portion of the latch element to prevent rotation of the cam in the first direction and to displace the cam in a second direction opposite the first direction, the displacement with respect to the first sash.

In a locked position the cam is arranged to displace in the first direction, the displacement with respect to the first sash. In some aspects, the cam and the at least one resilient element are in rotational equilibrium. In some aspects, when at least one of the first and second sashes is moved from an open position to a closed position, the cam is arranged to contact the latch element and displace in the second direction, the displacement with respect to the first sash. In some aspects, the displacement in the second direction enables further movement of the at least one of the first and second sashes. In some aspects, the first and second sashes are tiltable with respect to the plane, the first sash further comprises at least one first tilt latch lock, and the cam is engaged with the first tilt latch lock.

In some aspects, the at least one resilient element further comprises a first resilient element arranged to urge the cam in the first direction and a second resilient element arranged to urge the cam in the rotational direction. In some aspects, the first and second sashes are tiltable with respect to the plane, the first sash further comprises at least one second tilt latch lock including the second resilient element. In some aspects, the sliding window is selected from the group consisting of a double hung window, a single hung window, and a horizontally sliding window.

The invention further broadly comprises an automatic window locking assembly, including a rotatable cam, with a protrusion, arranged for at least indirect connection to a first sash of a sliding window; a latch element associated with the second sash; and a resilient element arranged to urge the cam in a direction at least partially orthogonal to a plane formed between the first and second sashes. When rotated to an unlocked position the cam is arranged to be displaced in a second direction, at least partially opposite the first direction, by contact between the protrusion and the latch element. In a locked position the cam is arranged to be displaced in the first direction. The displacement in the first and second directions is with respect to the first sash.

The invention broadly comprises an automatic window locking assembly, including a cam, with a protrusion, arranged for at least indirect connection to a first sash of a sliding window; a latch element associated with the second sash; a first resilient element arranged to urge the cam in a rotational direction; and a second resilient element arranged to urge the cam in a first direction at least partially orthogonal to a plane formed between the first and second sashes. When rotated to an unlocked position the cam is arranged so that the protrusion engages a portion of the latch element to prevent rotation of the cam in the rotational direction and to displace the cam in a second direction at least partially opposite the first direction. In a locked position the cam is arranged to displace in the first direction. The displacement in the first and second directions is with respect to the first sash.

The invention also broadly comprises an automatic locking assembly and sliding access control device, including a rotatable cam, with a protrusion, at least indirectly connected to a first component of the sliding access control device; a latch assembly associated with the second component; and at least one resilient element arranged to urge the cam in a first direction at least partially orthogonal to a plane formed between the first and second components and to urge the cam in a rotational direction. In a locked position, the cam is displaced in the first direction to engage the latch assembly. When rotated to an unlocked position the cam is arranged so that the protrusion engages a portion of the latch element to displace the cam in a second direction at least partially opposite the first direction. In the unlocked position the protrusion is engaged with the portion of the latch element to prevent rotation in the rotational direction. The displacement in the first and second directions is with respect to the first component.

The invention further broadly comprises an automatic locking assembly, including a rotatable cam, with a protrusion, arranged to at least indirectly connect to a first component of a sliding access control device; a latch element associated with the second component; and at least one resilient element arranged to urge the cam in a rotational direction. When rotated to an unlocked position the cam is arranged so that the protrusion engages a portion of the latch element to prevent rotation of the cam in the first direction.

It is a general object of the present invention to provide a simple and easy to use automatic lock for a window or door.

It is another object of the present invention to provide a lock that enables a user to open and close window sashes or door panels with minimal manipulation of the lock.

These and other objects and advantages of the present invention will be readily appreciable from the following description of preferred embodiments of the invention and from the accompanying drawings and claims.

### BRIEF DESCRIPTION OF THE DRAWINGS

FIG. 1 is a perspective view of a present invention automatic locking assembly in a locked position;

FIG. 2 is a perspective view of the cam element shown in FIG. 1 with the housing cut-away generally along line 2,4-2,4 in FIG. 1;

FIG. 3 is a perspective view of the latch element shown in FIG. 1;

FIG. 4 is a cross-sectional view generally along line 2,4-2,4 in FIG. 1;

FIG. 5 is a cross-sectional view generally along line 5-5 in FIG. 1;

FIG. 6 is a perspective view of the cam element shown in FIG. 1 in an unlocked position;

FIG. 7 is a cross-sectional view generally along line 7-7 in FIG. 6;

FIG. 8 is a perspective view of the automatic locking assembly shown in FIG. 1 in an intermediate position;

FIG. 9 is a perspective view of the cam element shown in FIG. 8 with the housing cut-away generally along line 9,10-9,10 in FIG. 8;

FIG. 10 is a cross-sectional view generally along line 9,10-9,10 in FIG. 8;

FIG. 11 is a perspective view of a window, with a present invention window locking assembly, in an open position;

FIG. 12 is a perspective view of the window shown in FIG. 11 in a closed position;

FIG. 13 is a cross-sectional view generally along line 13-13 in FIG. 12;

FIG. 14 is a perspective view of the automatic locking assembly shown in FIG. 1 as if the sashes are in an open position;

FIG. 15 is a perspective view of the automatic locking assembly shown in FIG. 14 as if the sashes are moved closer to a closed position;

FIG. 16 is a cross-sectional view generally along line 16-16 in FIG. 14;

FIG. 17 is a perspective view of a present invention automatic locking assembly with a slotted housing for a lever in an intermediate position;

FIG. 18 is a cross-sectional view generally along line 18-18 in FIG. 17;

FIG. 19 is a perspective view of the present invention automatic locking assembly in FIG. 17 in a locked position;

FIG. 20 is a perspective view of a present invention automatic locking assembly;

FIG. 21 is a perspective view of the automatic locking assembly shown in FIG. 20 in a locking position;

FIG. 22 is a perspective view of the latch element shown in FIG. 20;

FIGS. 23 through 27 are respective perspective views of the automatic locking assembly shown in FIG. 20 with the housing cut-away;

FIG. 28 shows the movement of the automatic locking assembly shown in FIG. 20 to an intermediate position;

FIG. 29 is a cross-sectional line generally along line 23,30-23,30 in FIG. 20, showing the automatic locking assembly of FIG. 20 in a locked position.

FIG. 30 is a cross-sectional line generally along line 23,30-23,30 in FIG. 20, showing the automatic locking assembly of FIG. 20 in an unlocked position.

FIG. 31 is a back perspective view of the automatic locking assembly shown in FIG. 20;

FIG. 32 is a perspective view of a present invention automatic locking assembly;

FIG. 33 is a perspective cut-away view of the automatic locking assembly shown in FIG. 32 generally along line 33,37-33,37 in FIG. 32 in an unlocked position;

FIG. 34 is a cross-sectional view of the automatic locking assembly shown in FIG. 33;

FIG. 35 is a cross-sectional view of the automatic locking assembly shown in FIG. 32 generally along line 33,37-33,37 in FIG. 32 in an intermediate position;

FIG. 36 is a perspective cut-away view of the automatic locking assembly shown in FIG. 32 generally along line 33,37-33,37 in FIG. 32 in a locked position; and,

FIG. 37 is a cross-sectional view of the automatic locking assembly shown in FIG. 36.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

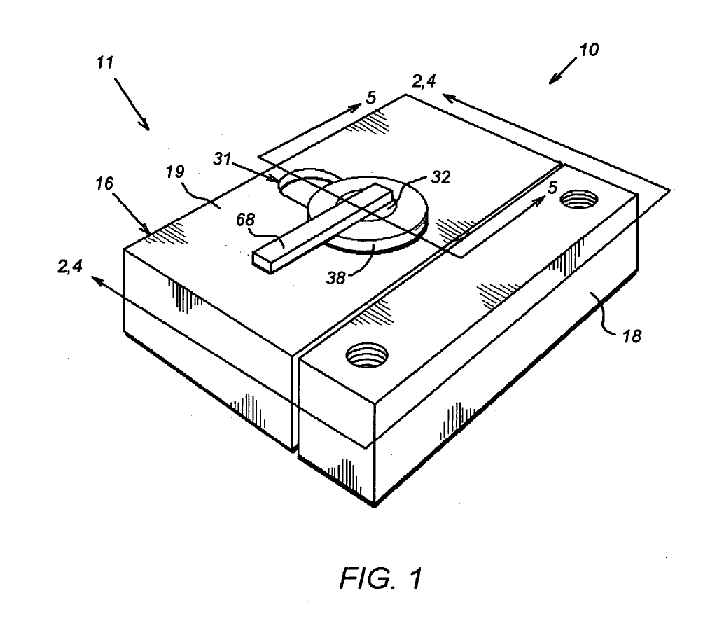

FIG. 1 is a perspective view of present invention automatic locking assembly 10 in a locked position.

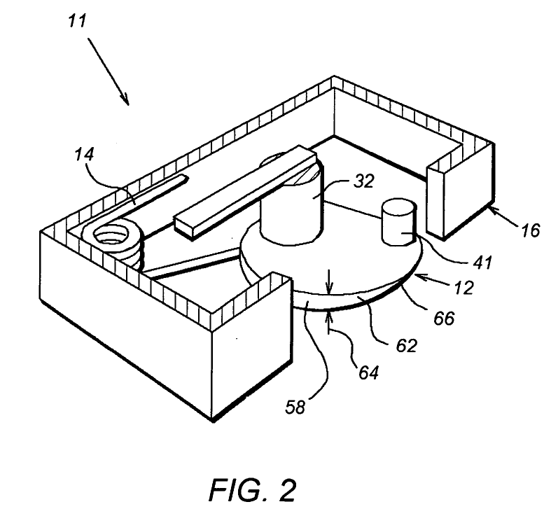

FIG. 2 is a perspective view of cam element 11 shown in FIG. 1 with the housing cut-away generally along line 2,4-2,4 in FIG. 1.

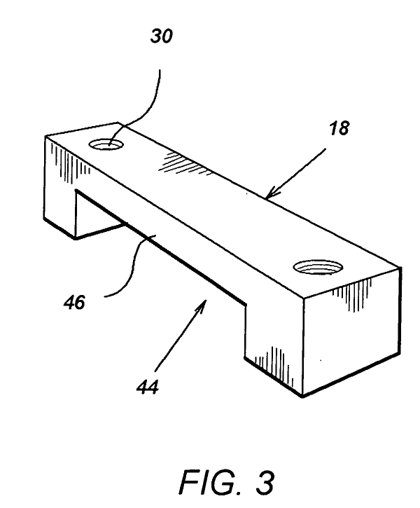

FIG. 3 is a perspective view of the latch element shown in FIG. 1.

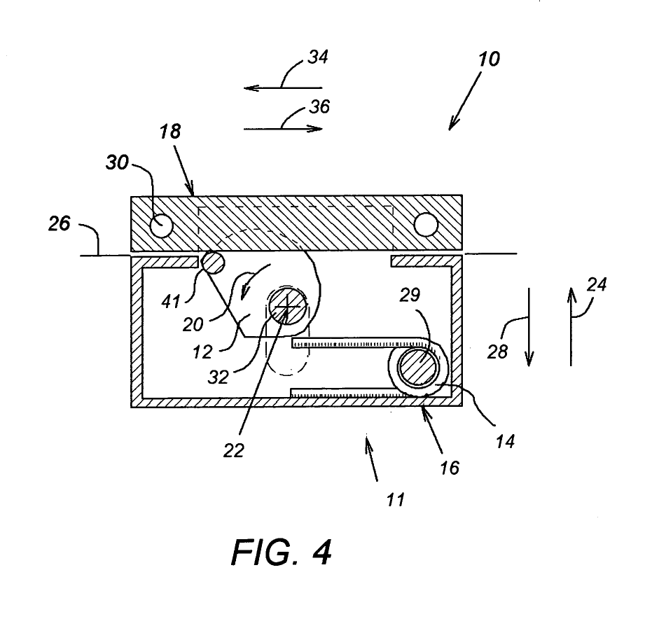

FIG. 4 is a cross-sectional view generally along line 2,4-2,4 in FIG. 1. The following should be viewed in light of FIGS. 1 through 4. To enable a clearer view of the configuration of the components of element 11, only the footprint of the latch element is shown in FIG. 4. Automatic locking assembly 10, otherwise referred to as automatic lock 10, includes cam 12, resilient element 14, and housing 16 of cam element 11, and latch element 18. Cam 12 and element 14 are at least partially disposed in the housing. Element 14 can be any resilient means known in the art, for example, a coil spring.

Cam 12 is arranged for at least indirect connection to a first component (not shown) of a sliding access control device (not shown). By at least indirect connection we mean that the cam is directly fastened to the component or the cam is connected to one or more other elements that in turn are connected to the component. Alternately stated, cam 12 is placed in the frame of reference of the component. In some aspects, cam 12 is connected to element 11, which is arranged for connection to the first component. Latch element 18 is associated with a second component (not shown) of the sliding access control device. By associated with, we mean the latch element is arranged to connect to the second component, or as described infra, is formed integrally with the second component. By access control device, we mean a window or a door. By a sliding access control device, we mean a window or door with one or more sliding sashes or door panels, respectively. Therefore, the first and second components can be sashes or door panels. It is understood that an access control device could be a combination of a window and a door. A sliding window can be any type known in the art, including, but not limited to a double hung window, a single hung window, or a window with one or more horizontally sliding sashes. For the sake of clarity, the following discussion is directed to a double hung window. However, it should be understood that the following discussion is applicable to any sliding access control device.

In some aspects, element 11 and housing 16 are fastened to the inner or lower sash of a double hung window by any means known in the art, including a compression, or snap, fit, adhesive, or mechanical fasteners, including but not limited to screws. In some aspects, the housing is configured as a “cap.” That is, there is no bottom surface opposite top 19. In some aspects, housing 16 is arranged to be fastened to the top of the meeting rail for the lower sash or the rail is formed with a recess or cavity to accept the housing. For example, the housing can be recessed in the rail such that the housing does not extend beyond the top surface of the rail, preserving the sight line for the window. In some aspects (not shown), housing 16 includes a bottom surface opposite top 19. In some aspects, element 11 and housing 16 are fastened to the sliding sash of a single hung window, the interior sash of a horizontally sliding window, or the panels of a sliding door and the preceding description is applicable.

In some aspects, latch 18 is arranged to be fastened to the top of the meeting rail for the upper sash or the rail is formed with a recess or cavity to accept the housing. For example, the latch element can be recessed in the rail such that the element does not extend beyond the top surface of the rail, preserving the sight line for the window. In some aspects, element 18 is fastened to the fixed sash of a single hung window, the exterior sash of a horizontally sliding window, or the panels of a sliding door and the preceding description is applicable. In some aspects (not shown), latch 18 is integral to the second component, for example, the latch is a recess formed in the component.

Resilient element 14 is arranged to urge cam 12 in rotational direction 20 about axis 22. Although direction 20 is shown as counterclockwise in the figures, it should be understood that in some aspects, direction 20 is clockwise. Element 14 also urges cam 12 in direction 24 orthogonal to plane 26 formed between the upper and lower sashes. It should be understood that only a portion of the force exerted by element 14 may be in direction 24. That is, the force may be a vector with one portion orthogonal to the plane. In short, element 14 urges the cam toward the second sash or the location the second sash occupies when the window is in a closed position. During normal opening and closing operations for the upper and lower sashes, the sashes are moved parallel to plane 26. It should be understood that an analog to plane 26 is formed between sashes of a single hung window, the sashes of a horizontally sliding window, and the panels of a sliding door. Resilient element 14 is in contact with cam 12, and in some aspects, with housing 16, and the position of cam 12 causes the cam to push against element 14 in direction 28, opposite direction 24. Thus, element 14 is compressed by cam 12 and the reactive force from the element pushes cam 12 in direction 24. Due to the shape of the cam and the location of axis 22, element 14 causes the cam to rotate in direction 20. In some aspects, cam 12 is arranged so that the cam rotates to reach a rotational equilibrium, for example, as shown in FIG. 4. That is, in FIG. 4, the reactive forces from element 14 cause no further rotation of the cam in direction 20 and the rotation of the cam is not otherwise constrained. In some aspects (not shown), the cam is restrained from rotating in direction 20 to reach an equilibrium position, for example by a pin contacting the housing. In some aspects, element 14 applies pressure to cam 12 in all positions for the cam.

In some aspects, resilient element 14 is connected to top 19 using any means known in the art, for example, post 29. In FIG. 2, post 29 has been removed to better show element 14. Latch element 18 can be connected to the upper sash using any means known in the art, for example, mechanical fasteners, such as screws, inserted through holes 30.

Non-rotational, hereafter referred to as lateral, movement of cam 12 is guided by a receiving portion, for example, slot 31 in the housing. In some aspects, post 32, aligned with axis 22, is at least partially disposed in the slot, which substantially locks the cam in directions orthogonal to the sides of the slots, for example, directions 34 and 36 parallel to plane 26. The slot enables rotational movement and movement along the slot, for example, directions 24 and 28. In FIG. 4, a dashed line is shown for the slot to show the relationship between the slot and post 32. In some aspects (not shown), post 32 does not extend up through the top of the housing. In these cases, the receiving portion can be a groove or ridge in the top of the housing arranged to accept the top of post 32.

It should be understood that the lateral movement of cam 12 and axis 22 described in the discussion above and below, for example, movement in directions orthogonal to plane 26, is with respect to the first sash or component, that is, the sash or component to which the cam is at least indirectly connected. Alternately stated, the lateral movement is not due to the movement of the sash or component itself, although such movement may be present. For example, window sashes may be drawn together laterally during a locking operation.

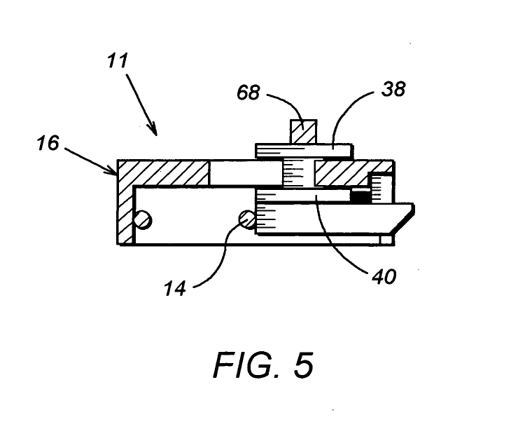

FIG. 5 is a cross-sectional view generally along line 5-5 in FIG. 1. The following should be viewed in light of FIGS. 1 through 5. In some aspects, post 32 includes collar 38 and shoulder 40. The shoulder and collar are shown in FIGS. 1 and 5 and omitted from the remaining figures to simplify the presentation, to allow a clear view of other elements of the assembly, and to enable a clearer view of the movement of post 32 in slot 31. The shoulder and collar are arranged to bracket top 19 to stabilize cam 12. For example, the shoulder and collar limit movement parallel to plane 26 and minimize wobble about axis 22. At the same time, the interface of the shoulder and collar with top 19 is loose enough to allow sufficient rotation of post 32 in directions 20, 24, and 28. In some aspects, collar 38 has a large enough diameter to cover slot 31. It should be understood that any means known in the art can be used to stabilize the cam while allowing the desired movement of the cam. For example, separate components can be attached to the post or the post can be integrally formed with stabilizing features.

In the figures, slot 31 is configured to be substantially orthogonal to plane 26. However, it should be understood that a slot in the housing can be oriented at an angle with respect to the plane. However, at least a portion of the lateral movement of cam 12 is orthogonal to plane 26. For example, if the lateral movement is viewed as a vector, a portion of the vector is orthogonal to the plane. Further, it should be understood that slot 31 can be straight, arcuate or a combination of straight and arcuate. Post 32 can be formed separately from cam 12 and connected to the cam by any means known in the art or can be formed integrally with the cam, that is, the post and cam are formed of a same piece of material.

The function of assembly 10 is now described in further detail. Cam 12 includes protrusion 41. In some aspects, the protrusion is integrally formed with the cam and in some aspects, the protrusion is formed separately from the cam and fixedly secured to the cam. Hereafter, the protrusion is referred to as a limiter. FIGS. 1, 2, and 4 show assembly 10 in a locked position. In the locked position, cam 12 is arranged to displace in direction 24 such that there is an overlap between the cam and latch element 18 parallel to plane 26. That is, when the upper and lower sashes are in the closed position, cam 12 is disposed so that limiter 41, which extends from cam 12 does not contact latch element 18 to prevent rotation of cam 12 in direction 20, and cam 12 is able to rotate to the position shown. When the upper and lower sashes are in an open position (with respect to plane 26, limiter 41 is out of orthogonal alignment with element 18) there is no impediment from the latch element to the rotation of the cam. Element 14 pushes the cam until post 32 contacts the end of the slot (not visible in FIG. 1), preventing further motion in direction 24. Thus, cam 12 extends past plane 26. When the sashes are closed, cam 12 extends into opening 44 of latch element 18, locking the upper and lower sashes.

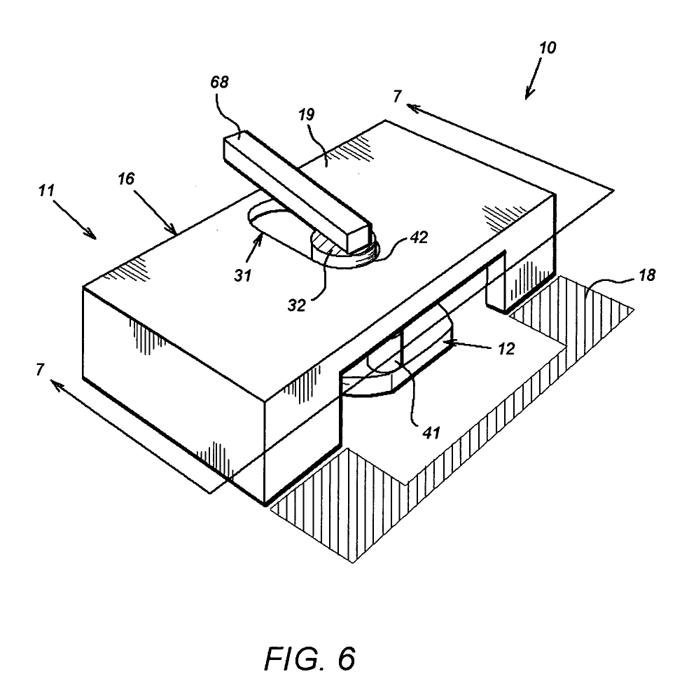

FIG. 6 is a perspective view of cam element 11 shown in FIG. 1 in an unlocked position.

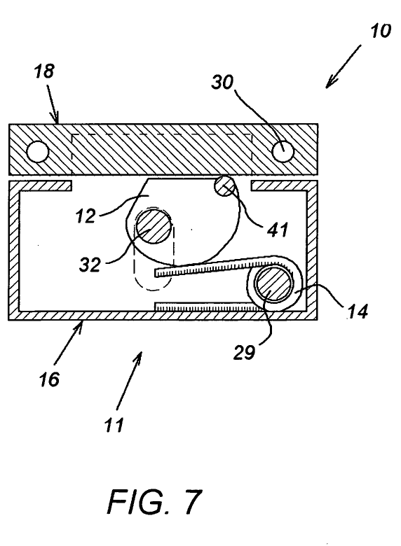

FIG. 7 is a cross-sectional view generally along line 7-7 in FIG. 6. The following should be viewed in light of FIGS. 1 through 7. Latch element 18 is not shown in FIGS. 6 and 7 to enable a clearer view of element 11. To enable a clearer view of the configuration of the components of element 11, only the footprint of the latch element is shown in FIG. 6. In FIG. 6, end 42 of slot 31 is visible. In FIG. 7, a dashed line is shown for slot 31 to show the relationship between the slot and post 32. In an unlocked position the cam, specifically, limiter 41, is arranged to engage portion 46 of the latch element to prevent rotation of the cam in direction 20. Further, when a user causes cam 12 to rotate from the locked position to the unlocked position limiter 41 passes along portion 46, displacing the cam in direction 28 so that there is no overlap between cam 12 and latch element 18 parallel to plane 26. That is, the cam does not extend far enough in direction 24 to engage the latch element or the upper sash, allowing movement between the sashes along plane 26.

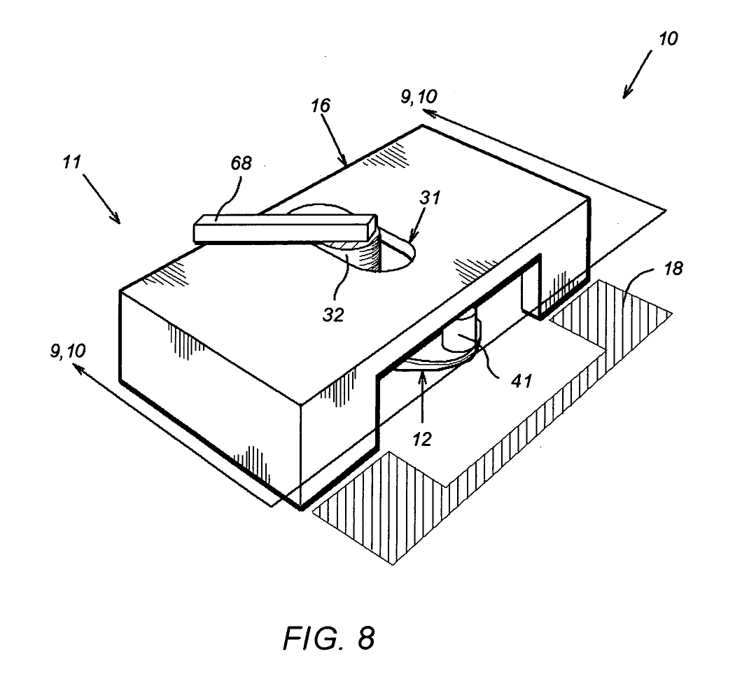

FIG. 8 is a perspective view of cam element 11 shown in FIG. 1 in an intermediate position.

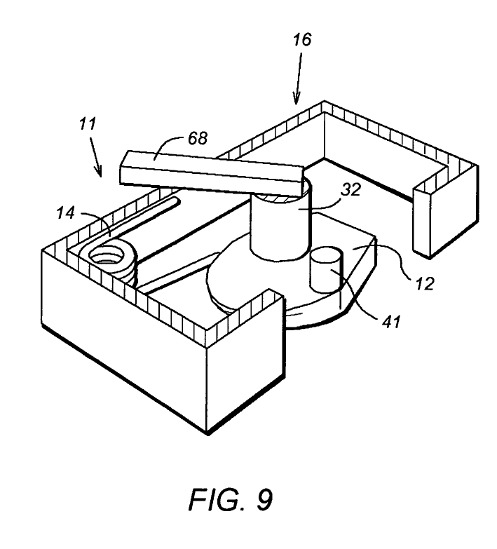

FIG. 9 is a perspective view of cam element 11 shown in FIG. 8 with housing 16 cut-away generally along line 9,10-9,10 in FIG. 8.

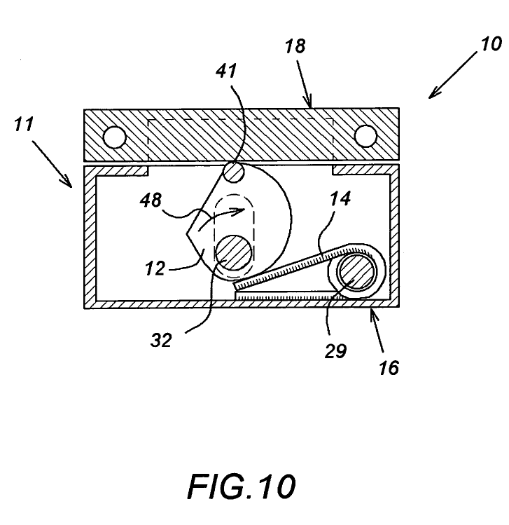

FIG. 10 is a cross-sectional view generally along line 9,10-9,10 in FIG. 8. The following should be viewed in light of FIGS. 1 through 10. To enable a clearer view of the configuration of the components of element 11, only the footprint of the latch element is shown in FIG. 8. In FIG. 9, post 29 has been removed to better show element 14. In FIG. 10, a dashed line is shown for slot 31 to show the relationship between the slot and post 32. The dynamic nature of assembly 10 can also be understood with reference to FIGS. 8 through 10. In FIGS. 8 and 10, the assembly is in an intermediate, or balanced, position. Post 32 (and axis 22) and limiter 41 are substantially orthogonally aligned with respect to plane 26 and the limiter is in contact with the latch element. Cam 12 has been displaced in direction 24 to a position partway between the ends of slot 31. In some aspects, the force from element 14 in direction 24 and the configuration of cam 12 cause cam 12 to remain in the intermediate position. As cam 12 is rotated in direction 48, opposite direction 20, from the intermediate position toward the unlocked position shown in FIG. 6, for example as shown in FIG. 9, the contact of limiter 41 with surface 46 prevents cam 12 from rotating back in direction 20. That is, in the absence of the contact, the force applied by element 14 to the cam causes the cam to rotate in direction 20 from the intermediate position. However, the resiliency of element 14 and the configuration of cam 12 are determined such that the forces acting on the cam in direction 20 are checked as the cam moves from the intermediate to the unlocked position.

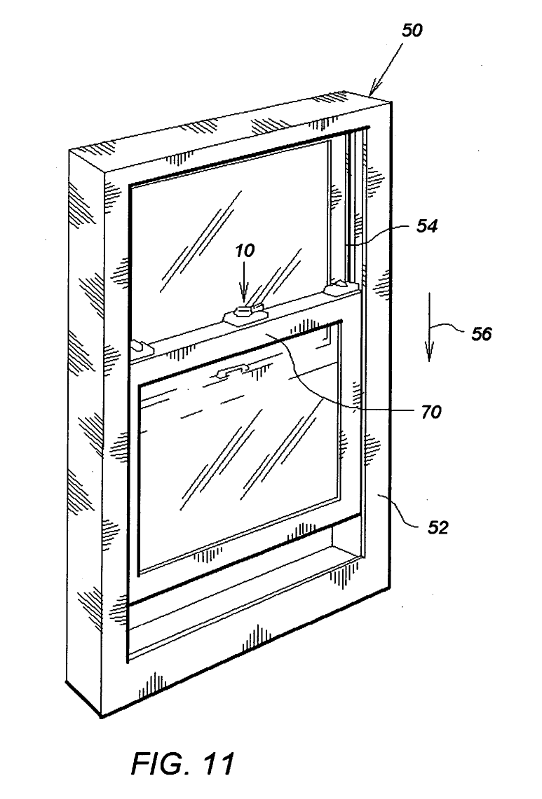

FIG. 11 is a perspective view of window 50, with locking assembly 10, in an open position.

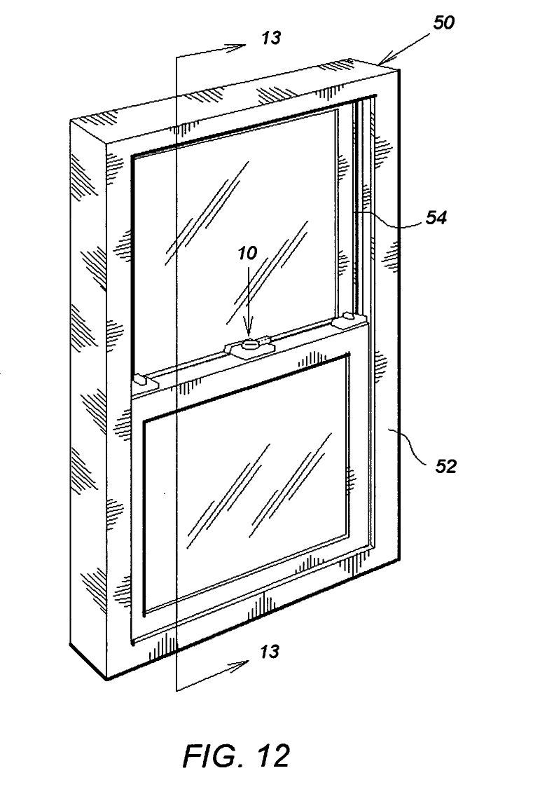

FIG. 12 is a perspective view of window 50 shown in FIG. 11 in a closed position.

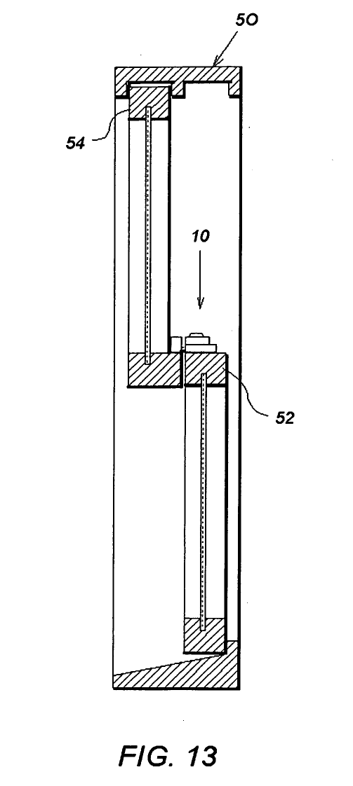

FIG. 13 is a cross-sectional view generally along line 13-13 in FIG. 12. The following should be viewed in light of FIGS. 1 through 13. Assembly 10 automatically reverts to the locked position when sashes 52 and 54 are moved from the closed position to the open position such that the rotation of cam 12 in direction 20 is no longer restrained by the contact of limiter 41 with latch 18, in particular, surface 46. That is, the sashes are in a position such that there is no overlap, orthogonal to plane 26, between limiter 41 and surface 46. For example, in FIG. 11, sashes 52 and 54 are in an open position. As sash 52 is moved in direction 56, the sashes assume the closed position shown in FIG. 12.

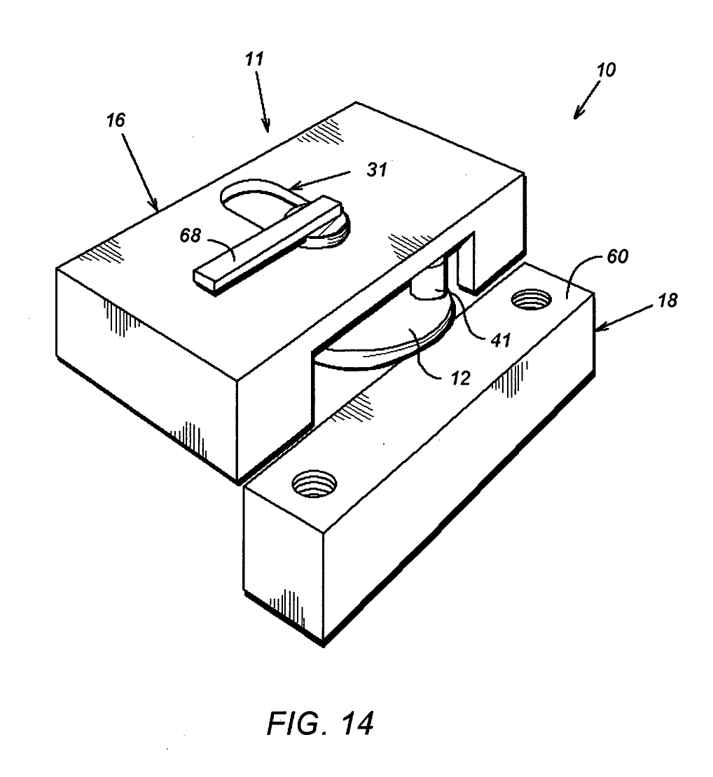

FIG. 14 is a perspective view of automatic locking assembly 10 shown in FIG. 1 as if the sashes to which the assembly would be connected are in an open position.

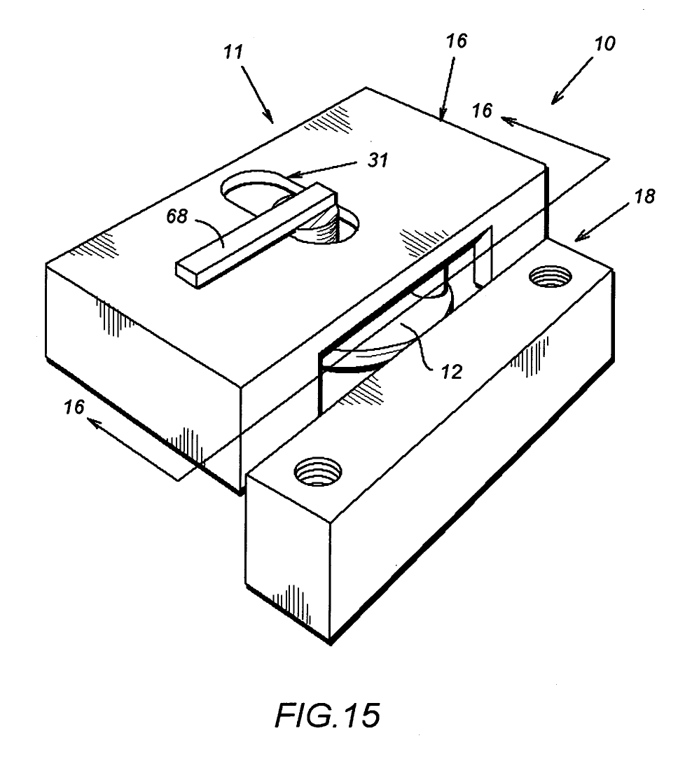

FIG. 15 is a perspective view of automatic locking assembly 10 shown in FIG. 14 as if the sashes are moved closer to a closed position.

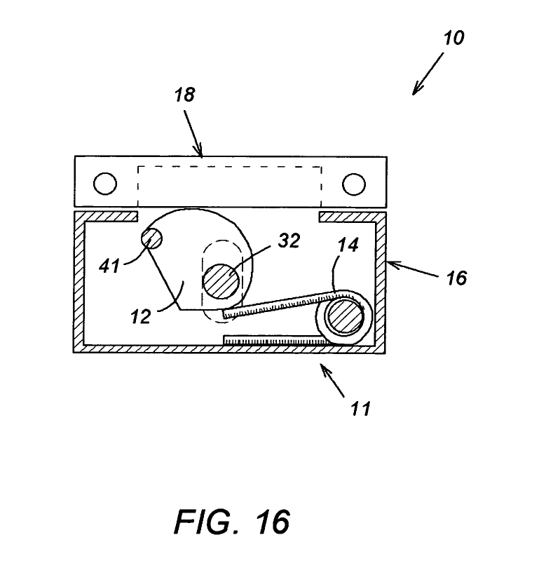

FIG. 16 is a cross-sectional view generally along line 16-16 in FIG. 15. The following should be viewed in light of FIGS. 1 through 16. In FIG. 16, a dashed line is shown for slot 31 to show the relationship between the slot and post 32. Due to the shape of the cam and the ability of the cam to displace in direction 28, sashes can be moved from the open position to the closed position without manipulation of assembly 10 by the window user. That is, as shown in FIGS. 14 through 16, when one of sashes 52 or 54, in this case, 52, is displaced, in this case, in direction 56, from the open position, the cam is arranged to contact latch element 18 and displace in direction 28. Specifically, in the process of moving from the open to the closed positions, cam 12 contacts latch 18 as shown in FIG. 14. Bottom surface 58 of the cam contacts top surface 60 of the latch. In some aspects, cam 12 includes bevel 62 or any configuration known in the art such that thickness 64 of the cam decreases from front edge 66 to facilitate the movement of the cam in direction 28 as sash 52 and the cam are moved in direction 56. That is, the displacement of the cam in direction 28 enables the further movement of one of the upper or lower sashes, in this case, sash 52, in direction 56. It should be understood that the preceding discussion is applicable to any combination of movement between sashes 52 and 54 that results in the movement of the sashes between the open and closed positions. Thus, the only manipulation of assembly 10 required of the user is the initial rotation of cam 12 from the locked to the unlocked position when the sashes are in the closed position.

In FIG. 15, sash 52 has been moved sufficiently far in direction 56 and cam 12 has displaced sufficiently far in direction 28, such that front surface 66 is in contact with surface 46 of the latch. As sash 52 is moved further in direction 56 to reach the position shown in FIG. 12, cam 12 moves past surface 46 and the force from element 14 displaces the cam in direction 24 so that a portion of the cam enters opening 44 in the latch. That is, as at least a portion of cam 12, in particular limiter 41, reaches alignment, orthogonal to plane 26, with opening 44, the cam is arranged to displace in direction 24 such that a portion of the cam enters opening 44. Thus, without any intervention from the user, assembly 10 automatically assumes the locked position when the user closes window 50.

Assembly 10 includes a means for applying force to the cam to rotate the cam about axis 22, for example, between the locked and unlocked positions. In some aspects, assembly 10 includes rotation element 68, or lever 68, connected to cam 12, in particular, to post 32. Lever 68 can be any lever known in the art. In some aspects, the lever is connected to the post by any means known in the art. In some aspects, the lever is integral to the post. It should be understood that other orientations, configurations, and locations of the means for applying force to the cam are included in the spirit and scope of the claimed invention. For example, a lever, knob, or slider could be located away from housing 16 and connected to the cam, for example, post 32, by a rod, extension, or other means. An example of the preceding configuration is a tilt-window with tilt latches located near the sash stiles. The tilt latches can be connected to the cam with an extension rod or other means so that the movement of the tilt latches associated with opening the latches applies a force to rotate cam 12 as needed to place assembly 10 in the open position. A lever, knob, or slider could be positioned on face 70 of the rail.

In some aspects (not shown), assembly 10 includes two resilient elements arranged to apply force to the cam. A first resilient element urges the cam in direction 24 and the second resilient element urges the cam in direction 20. For example, for a tilt-window with tilt latches, the first resilient element could be associated with one of the tilt latches and the second resilient element could be located in housing 16.

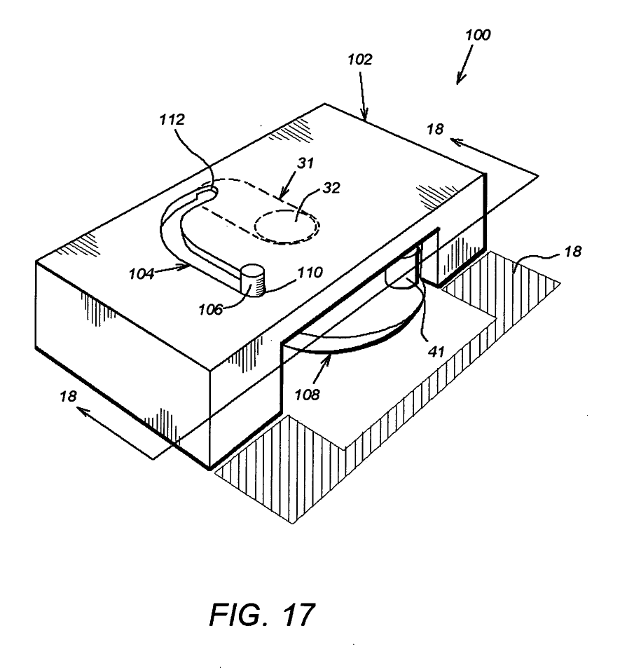

FIG. 17 is a perspective view of present invention automatic locking assembly 100 with slotted housing 102 for pin 106 in a locked position.

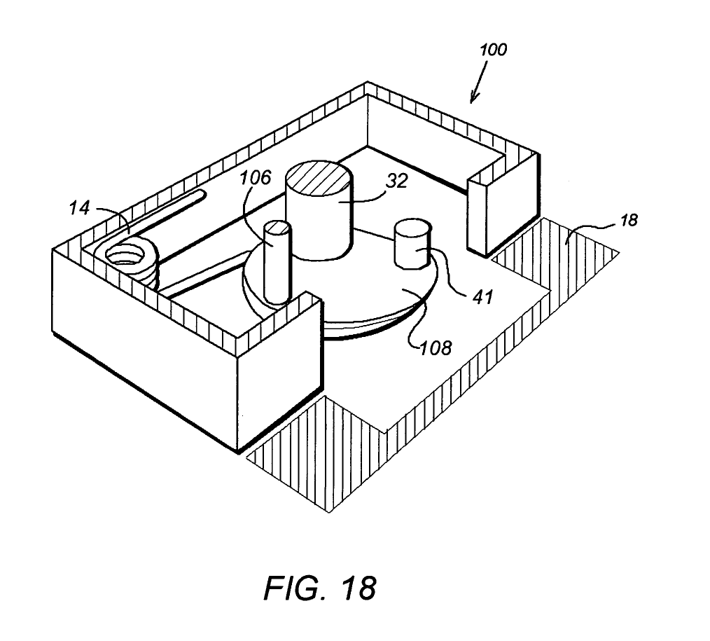

FIG. 18 is a cross-sectional view generally along line 18-18 in FIG. 17.

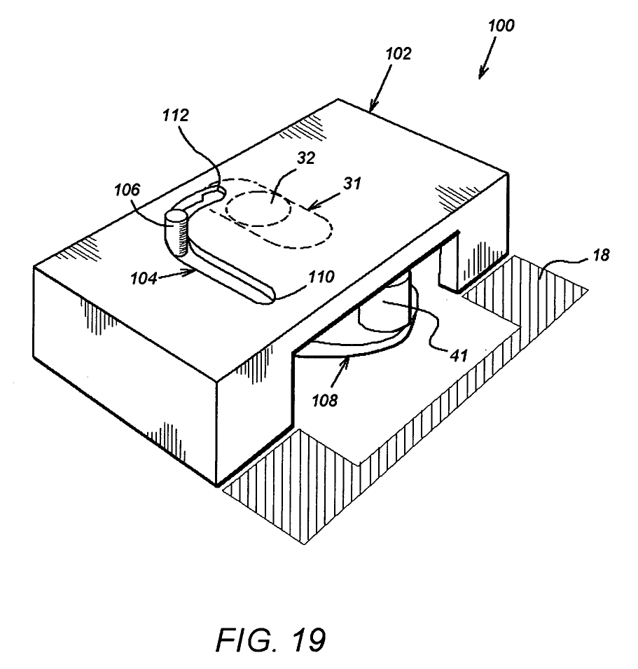

FIG. 19 is a perspective view of assembly 100 in FIG. 17 in an intermediate position. To clarify the presentation, latch element 18 is shown by a hatched footprint. The following should be viewed in light of FIGS. 1 through 19. In some aspects, a present invention assembly includes a slot in the housing for a lever used to rotate the cam. For example, assembly 100 includes housing 102 with slot 104. In some aspects, pin, or lever, 106 is integral to cam 108 and in some aspects, pin 106 is formed separately from the cam and connected to the cam. The movement of lever 106 through slot 104 causes rotation and lateral movement of cam 108. The rotation and lateral movement of cam 108 resulting from the movement of pin 106 is substantially the same as the movement described for cam 12 in FIGS. 1 through 16. Also, the interaction of cam 108 and protrusion 41 with latch 18 is substantially the same as the movement described for cam 12 in FIGS. 1 through 16. Thus, the overall operation of cam 108 with respect to locked, unlocked, and intermediate positions is substantially the same as described for cam 12 in FIGS. 1 through 16. Alternately stated, the operation of assembly 100 is substantially the same as the operation of assembly 10, with the exception of the operation associated with pin 106 and lever 68, respectively.

In FIG. 17, assembly 100 is in the locked position and cam 108 is in rotational equilibrium. As pin 106 is moved through the slot from end 110 toward end 112, the cam reaches the intermediate position shown in FIG. 19. As the pin is moved to end 112 (not shown), cam 108 rotates into the unlocked position, for example, as described for cam 12 in FIG. 6. In some aspects, pin 106 is substantially opposite limiter 41, however, it should be understood that other configurations of pin 106 are possible. In some aspects (not shown), another component such as a slide handle, knob, wire, or rod are used in conjunction with pin 106. In some aspects (not shown), pin 106 does not extend beyond the top of the housing. It should be understood that other locations, sizes, and configurations for slot 104 are within the spirit and scope of the invention as claimed. In FIGS. 17-19, post 32 engages groove 31.

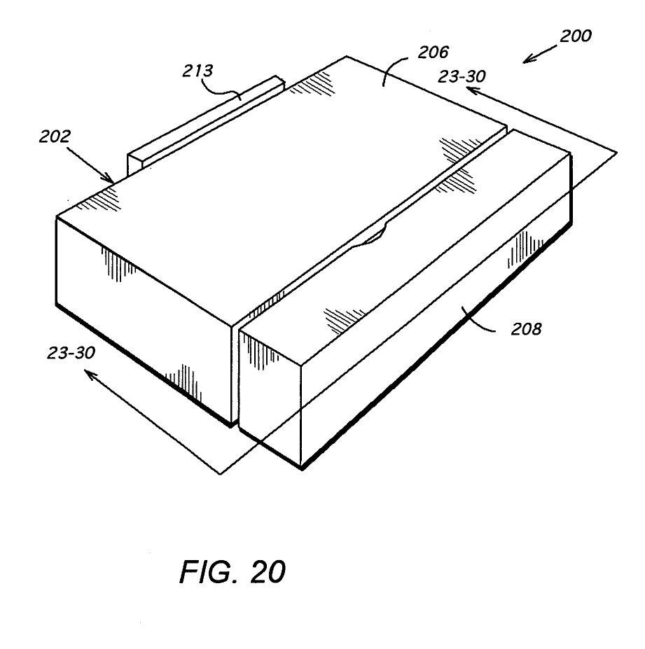

FIG. 20 is a perspective view of present invention automatic locking assembly 200.

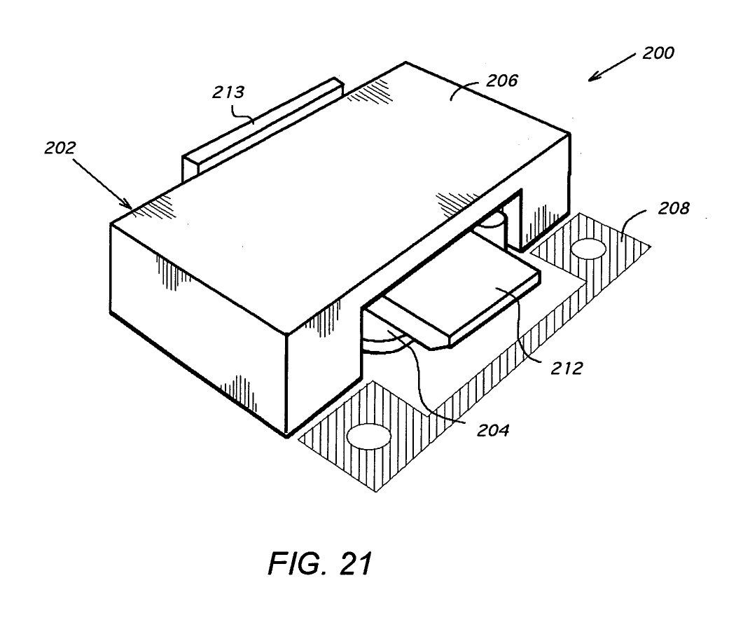

FIG. 21 is a perspective view of cam element 202 shown in FIG. 20.

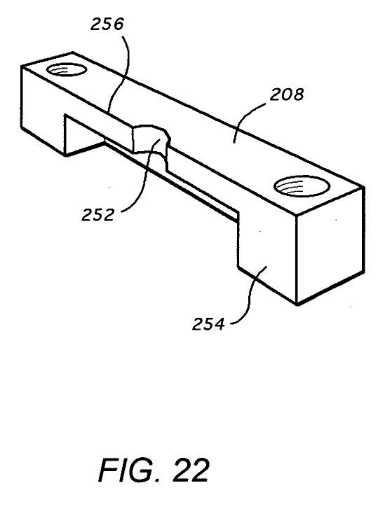

FIG. 22 is a perspective view of the latch element shown in FIG. 20. The following should be viewed in light of FIGS. 1 through 22. To enable a clearer view of the configuration of the components of element 202, only the footprint of the latch element is shown in FIG. 21. Automatic locking assembly 200, otherwise referred to as automatic lock 200, includes cam 204, housing 206 of cam element 202, latch element 208, and slide element, or bolt, 212. Cam 204 is at least partially disposed in the housing. In some aspects, assembly 200 includes handle 213. In general, cam 204 rotates and displaces as described for cam 12 in FIGS. 1-16. However, cam 204 does not directly create a lock between components. Instead, cam 204 operates on bolt 212 so that the bolt locks the components.

In some aspects, handle 213 is provided to enable a user to operate cam 204. However, it should be understood that in some aspects (not shown), assembly 200 is provided with means as described in FIGS. 1-16, which a user can manipulate to operate cam 204. Further, it should be understood that in some aspects (not shown) the handle arrangement shown in FIG. 20 can be used in the locking assemblies shown in FIGS. 1-16.

As described for cam 12 in FIGS. 1-16, cam 204 is arranged for at least indirect connection to a first component (not shown) of a sliding access control device (not shown). The discussion in the description for cam 12 regarding connection of the cam is generally applicable to cam 204. In general, the discussion regarding cam 12, element 11, element 18, and a sliding access control device in FIGS. 1-16 is applicable to cam 204, element 202, and element 208. The discussion regarding element 11 and housing 16 and the inner or lower sash of a double hung window in FIGS. 1-16 is applicable to element 202 and housing 206. The discussion regarding the connection and configuration of housing 16 in FIGS. 1-16 is generally applicable to housing 206. In some aspects, element 202 and housing 206 are fastened to the sliding sash of a single hung window, the interior sash of a horizontally sliding window, or the panels of a sliding door and the preceding description is applicable.

In general, the discussion regarding latch 18 and a upper sash or rail, or the fixed sash of a single hung window, the exterior sash of a horizontally sliding window, or the panels of a sliding door in FIGS. 1-16 is applicable to latch 208. For the sake of simplicity, the discussion that follows assumes that assembly 200 is engaged with a double hung window, however, it should be understood that assembly 200 is not limited to use with a double hung window.

The discussion regarding cam 12 and resilient element 14 in FIGS. 1-16 is generally applicable to cam 204 and a resilient element (not shown) in element 202. The discussion regarding the rotation and lateral movement of cam 12 in FIGS. 1-16 is generally applicable to cam 204. However, as explained below, cam 204 does not directly act to lock the sashes for a double hung window. Instead, cam 204 operates to slide bolt 212 so that the bolt locks the sashes.

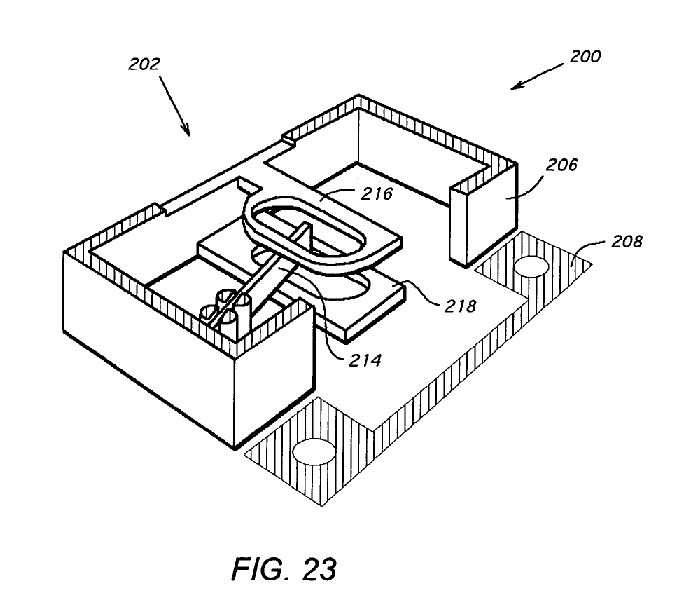

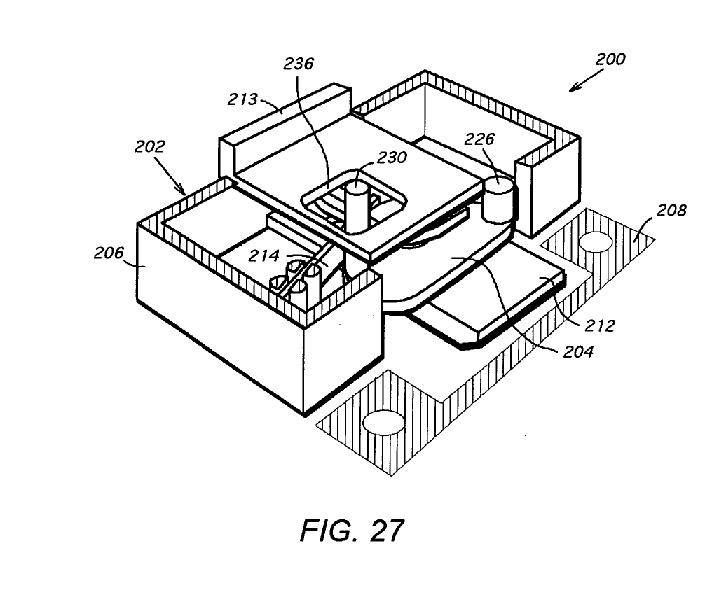

FIGS. 23 through 27 are respective perspective views of automatic locking assembly 200 shown in FIG. 20 with housing 206 cut-away along line 23-30. The following should be viewed in light of FIGS. 1 through 27. FIGS. 23 and 27 present a sequence in which components of assembly 200 are added. This sequence is intended to allow a clear view of how the components of the assembly interface and interact. However, it should be understood that a present invention assembly is not limited to the configuration and sequence shown.

FIG. 23 shows resilient element 214, bracket 216, and bracket 218. In general, the discussion regarding resilient element 14 in FIGS. 1-16 is applicable to element 214. Resilient element operates on cam 204 as further described.

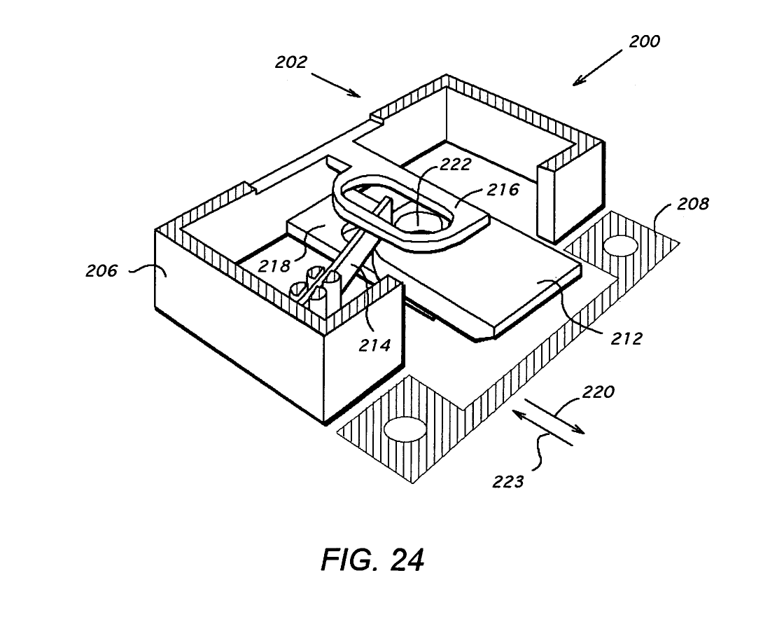

FIG. 24 shows the position of bolt 212 between brackets 216 and 218. In some aspects, the bolt is disposed below the resilient element. In some aspects (not shown), resilient element 214 is arranged to engage the bolt to urge the bolt in direction 220 or the assembly includes a second resilient element arranged to urge the bolt in direction 220. In some aspects, bolt 212 includes opening 222. As described below, the opening is arranged to receive a post for cam 212 so that the movement of bolt 212 in directions 220 and 223 is locked with the movement of cam 204 in directions 220 and 223.

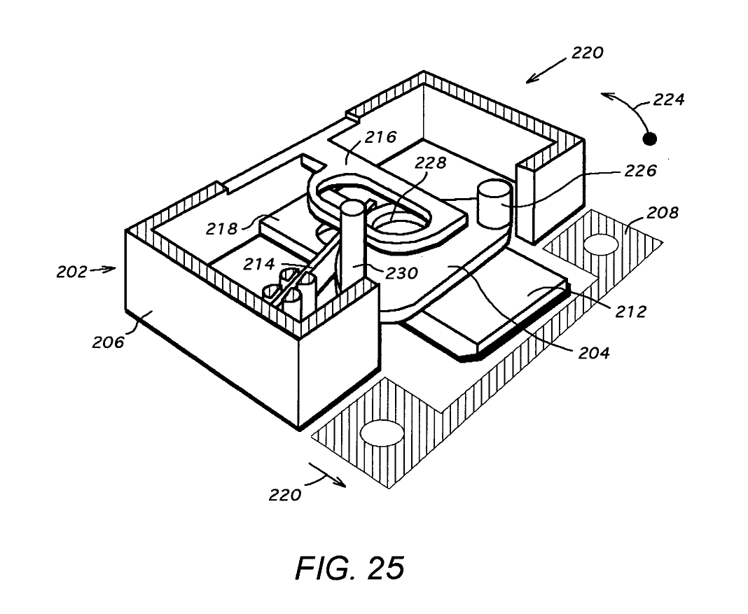

FIG. 25 shows a position of cam 204 in element 202. In some aspects, cam 204 is disposed between bracket 216 and bolt 212. In some aspects (not shown), cam 204 is disposed between bolt 212 and bracket 218. Resilient element 214 is in contact with cam 204 and applies force to the cam. In general, the discussion in FIGS. 1-16 regarding the interaction of cam 12 and resilient element 14 is applicable to cam 204 and element 214. For example, element 214 urges cam 204 to rotate in direction 224 and laterally displace in direction 220. Since bolt 212 displaces in direction 220 to lock the sashes, cam 204 does not need an extension that directly locks the sashes. Cam 204 includes protrusion, or limiter, 226 and the discussion regarding protrusion 41 and the interaction of protrusion 41 with latch element 18 in FIGS. 1-16 is applicable to protrusion 226 and latch element 208, except as noted. In some aspects, cam 204 includes opening 228 arranged to receive a post (not shown) for the cam and the cam is arranged to rotate about the post. In some aspects (not shown), a post is formed integrally with the cam. Cam 204 also includes post 230 arranged to engage the handle. Post 230 can be formed integrally with the cam or can be formed separately from the cam and secured to the cam by any means known in the art.

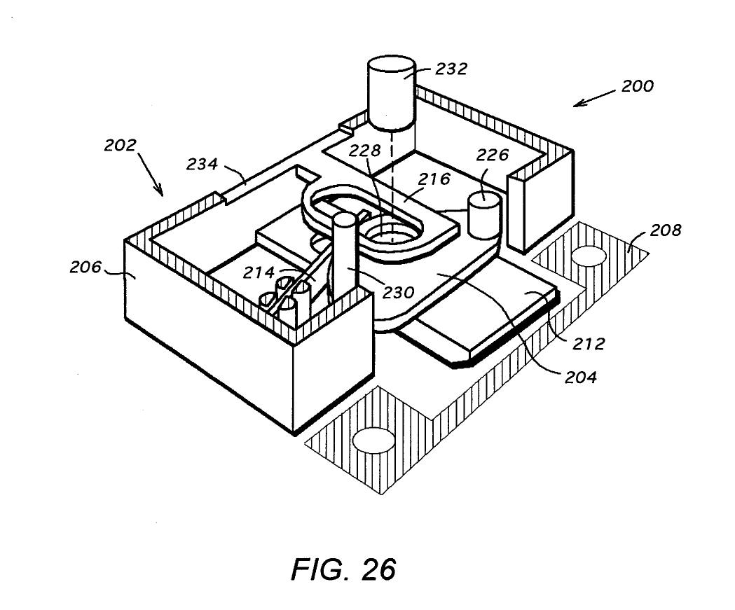

FIG. 26 shows post 232 inserted through opening 228 in cam 204. Post 232 also engages opening 222 in the bolt. The engagement with opening 222 can be fixed, or rotation between the post and opening 222 can be enabled. In some aspects, housing 206 includes notch 234, used to interface with handle 213.

FIG. 27 shows the interconnection of handle 213 with cam 204. In some aspects, handle 213 is disposed over cam 204 and in notch 234. Opening 236 in handle 213 is arranged to receive post 230. In FIGS. 23-27, assembly 200 is in a locked position. That is, bolt 212 is extended in direction 220 by the action of resilient element 214 and cam 204. In some aspects, cam 204 is in rotational equilibrium in the locked position.

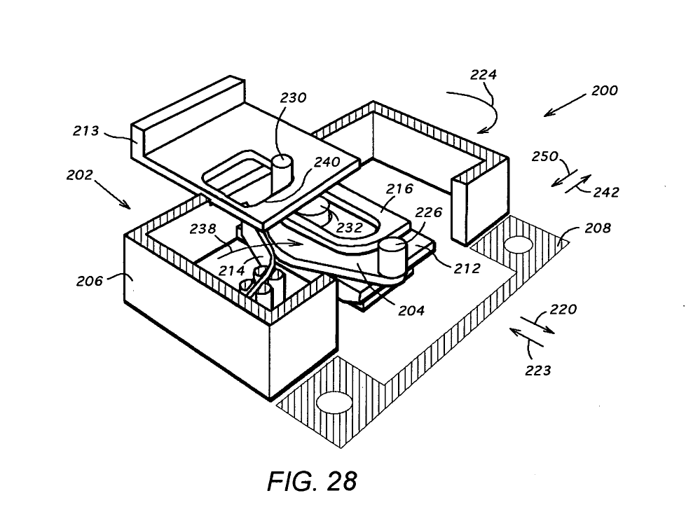

FIG. 28 shows the movement of assembly 200 to an intermediate position. Handle 213 has been moved in direction 223. The movement of the handle causes pin 230, engaged with the handle through opening 236, to move in direction 223 as well. The movement of the handle, the force from the leaf spring in direction 238, and the rotation of cam 204 causes post 230 to move along edge 240 of opening 236 in direction 242. Specifically, the movement of pin 230 causes the cam to rotate about post 232. As the cam rotates in direction 224, limiter 226 slides along element 208, similar to as has been described for cam 12 in FIGS. 1-16. As limiter 226 moves along latch 208 in direction 250, the limiter engages notch 252 in the latch element, stabilizing the cam in the position shown in the figure. In some aspects, notch 252 is substantially aligned, orthogonal to face 254 of latch 208, with post 232. In some aspects, notch 252 is in direction 250 past a line orthogonal to face 254 and aligned with post 232.

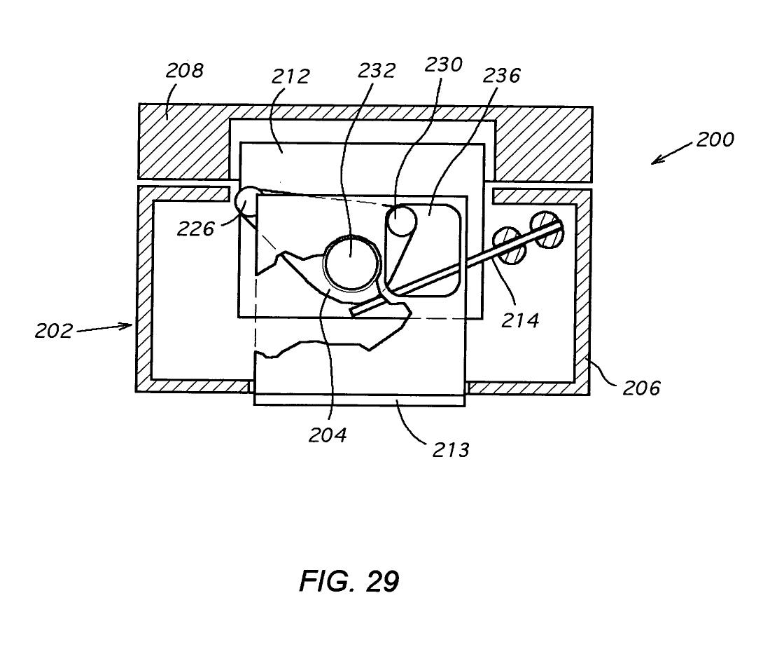

FIG. 29 is a cross-sectional line generally along line 23-30 in FIG. 20, showing assembly 200 in a locked position.

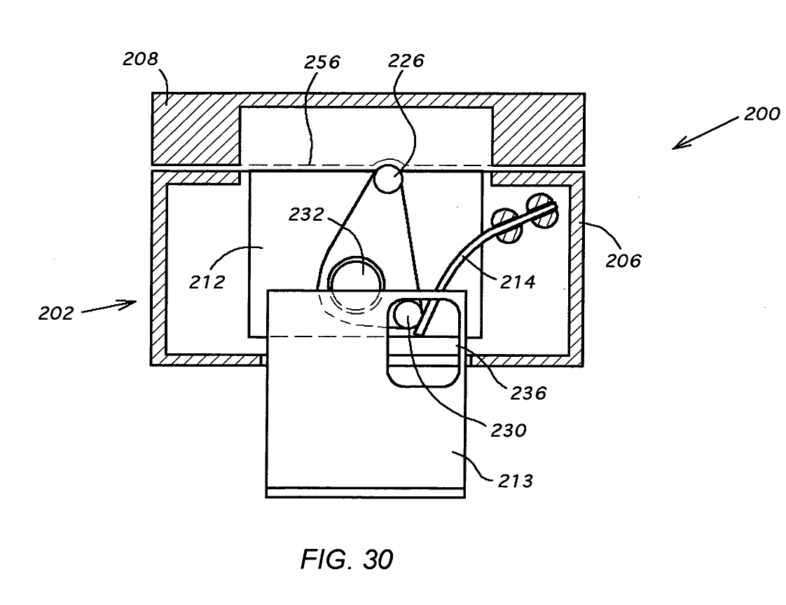

FIG. 30 is a cross-sectional line generally along line 23-30 in FIG. 20, showing assembly 200 in an unlocked position. In FIG. 30, edge 256 on latch 208 is shown with a dashed line.

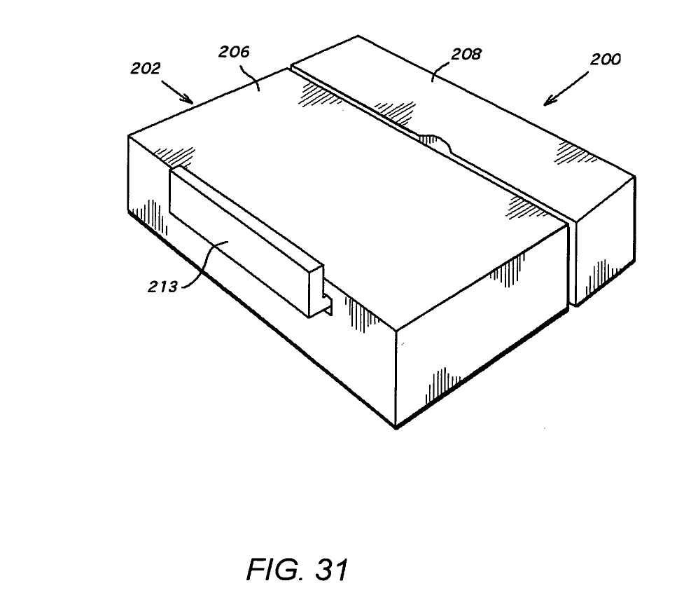

FIG. 31 is a back perspective view of assembly 200 shown in FIG. 20.

It should be understood that for the sake of clarity of presentation not all the ancillary part of assembly 200 have been shown. For example, any means known in the art can be used to stabilize and guide the various moving and sliding components, such as cam 204 and bolt 212.

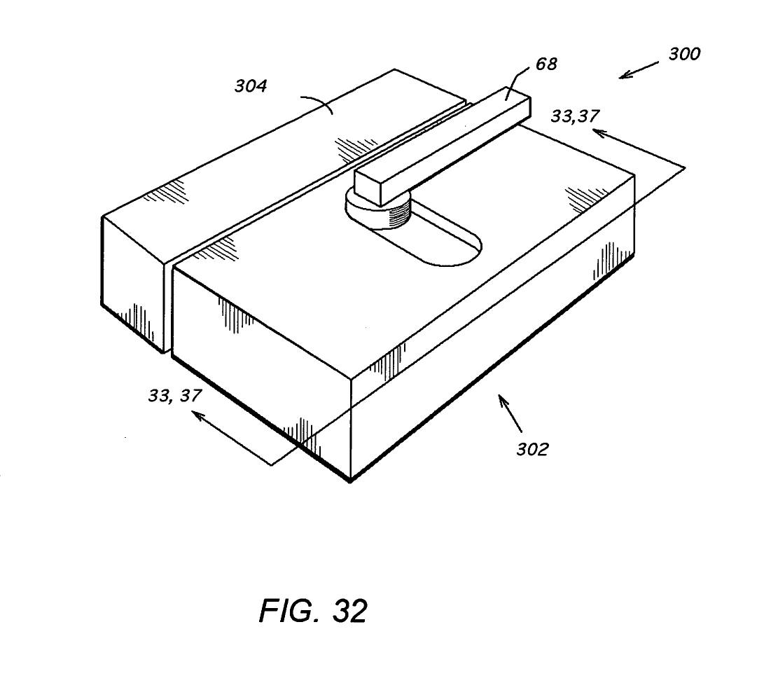

FIG. 32 is a perspective view of present invention automatic locking assembly 300.

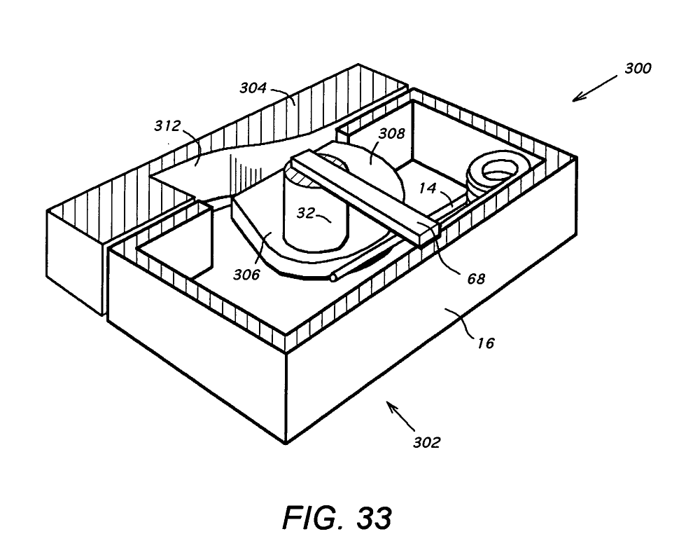

FIG. 33 is a perspective cut-away view of automatic locking assembly 300 shown in FIG. 32 generally along line 33,37-33,37 in FIG. 32 in an unlocked position.

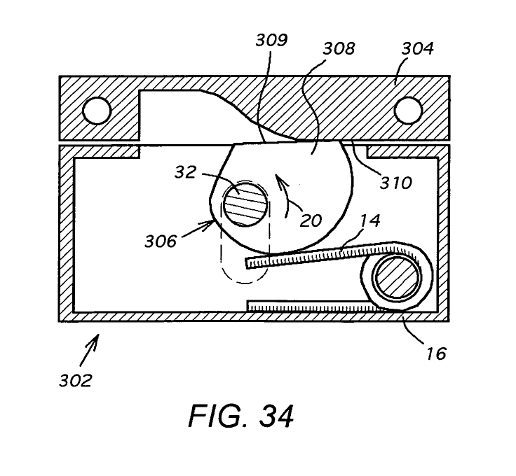

FIG. 34 is a cross-sectional view of automatic locking assembly 300 shown in FIG. 33. The following should be viewed in light of FIGS. 1-16 and 32-34. Assembly 300 includes cam element 302 and latch element 304. With the exception of certain aspects of cam 306 and latch element 304, assembly 300 is substantially the same as assembly 10 described in FIGS. 1-16. Therefore, the description of assembly 10 in FIGS. 1-16 is applicable to assembly 300 except as described below. Although the rotational and lateral movement of cam 306 is substantially the same as the rotational and lateral movement of cam 12 described in FIGS. 1-16, the interaction of cam 306 with latch element 304 is different than the interaction of cam 12 with element 18 described in FIGS. 1-16. To enable the different interaction, the shape of cam 306 and latch element 304 is different than the shapes of cam 12 and element 18, respectively, described in FIGS. 1-16.

In FIGS. 33 and 34, assembly 300 is in an unlocked position. Cam 306 is being held in this position by contact with latch element 304. In FIGS. 1-16, protrusion 41 of cam 12 contacts portion 46 of element 18. In FIGS. 33 and 34, protrusion 308 of cam 306, in particular face 309, is in contact with face, or portion, 310 of element 304. Thus, face 310 prevents cam 306 from rotating in direction 20.

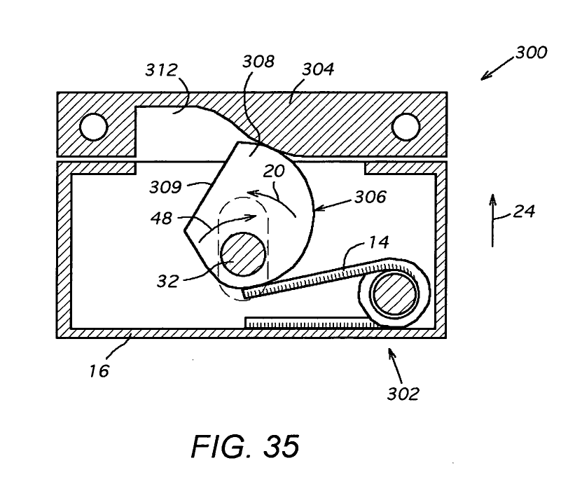

FIG. 35 is a cross-sectional view of automatic locking assembly 300 shown in FIG. 32 generally along line 33,37-33,37 in FIG. 32 in an intermediate position. The following should be viewed in light of FIGS. 1-16 and 32-35. In FIG. 35, cam 306 is rotated in direction 20, for example, as described for cam 12 in FIGS. 1-16. However, cam 306 and element 304 are shaped differently than cam 12 and element 18, respectively, in FIGS. 1-16. Thus, as cam 304 rotates, protrusion 308 of the cam enters indentation, or portion, 312 of element 304. Since the indentation increases in direction 24, element 14 pushes cam 306 in direction 24 as the cam slides into the indentation.

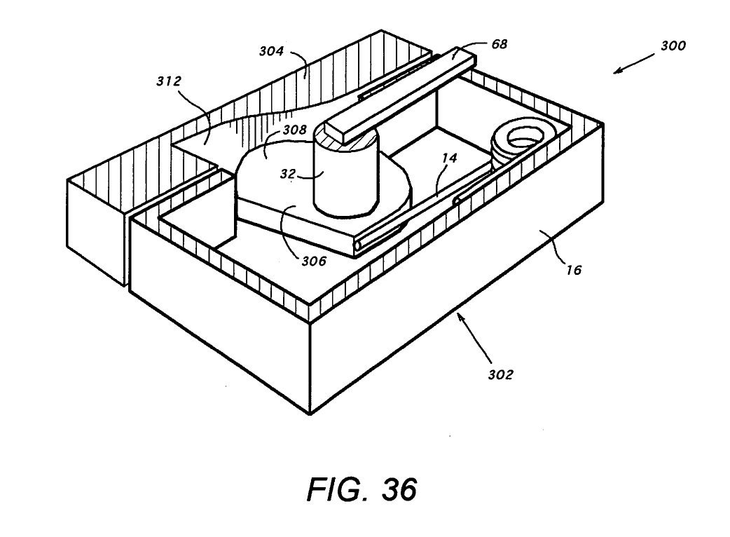

FIG. 36 is a perspective cut-away view of automatic locking assembly shown 300 in FIG. 32 generally along line 33,37-33,37 in FIG. 32 in a locked position.

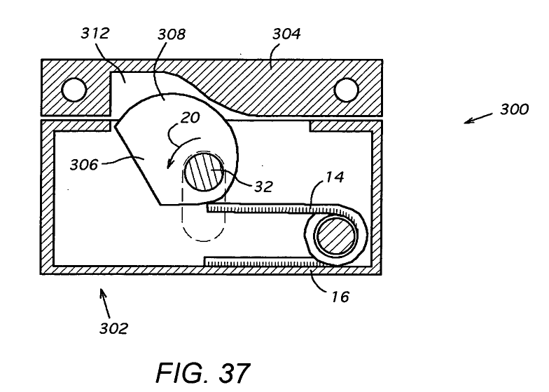

FIG. 37 is a cross-sectional view of automatic locking assembly 300 shown in FIG. 36. The following should be viewed in light of FIGS. 1-16 and 32-37. In FIGS. 36 and 37, cam 306 has rotated to the locked position in a manner similar to that described for cam 12 in FIGS. 1-16. For example, in some aspects, the position shown in FIGS. 36 and 37 is a rotational equilibrium position for the cam. That is, the force exerted by element 14 tends to move cam 306 into the locked position. Protrusion 308 of cam 306 acts to lock components of a sliding access control device as described for cam 12 in FIGS. 1-16.

It should be understood that a present invention assembly is not limited to the sizes, shapes, configurations, and numbers of components shown in the drawings and that other sizes, shapes, configurations, and numbers of components are included within the spirit and scope of the claimed invention.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. An automatic locking assembly, comprising:
a rotatable cam arranged to at least indirectly connect to a first component of a sliding access control device; and,
at least one resilient element arranged to urge said cam in a first direction at least partially orthogonal to a plane formed between said first and second components, wherein an axis of rotation for said cam is arranged to displace in said first direction, said displacement with respect to said first component, and wherein said cam is rotatable independent of said displacement.

2. The automatic locking assembly of claim 1 wherein said sliding access control device further comprises a second component and said cam is arranged to lock said first component and said second component.

3. The automatic locking assembly of claim 1 further comprising a slide element connected to said cam, wherein said sliding access control device further comprises a third component, and wherein said cam is arranged to displace said slide element to lock said first component and said third component.

4. The automatic locking assembly of claim 1 wherein in a locked position, said axis is arranged to displace in said first direction.

5. The automatic locking assembly of claim 4 wherein when said cam is rotated to an unlocked position, said axis is arranged to displace in a second direction at least partially opposite said first direction, said displacement in said second direction with respect to said first component.

6. The automatic locking assembly of claim 5 wherein said cam further comprises a protrusion; and,
the assembly further comprising a latch assembly associated with said second component, wherein when rotated to said unlocked position said protrusion is arranged to engage a first portion of said first latch element to displace said cam.

7. The automatic locking assembly of claim 6 wherein said at least one resilient element is arranged to urge said cam in a rotational direction and wherein when rotated to said unlocked position said protrusion is arranged to engage a second portion of said latch element to prevent rotation in said rotational direction.

8. The automatic locking assembly of claim 1 wherein said sliding access control device is selected from the group consisting of a sliding window and a sliding door and wherein said first and second components are selected from the group consisting of a window sash and a door panel.

9. The automatic locking assembly of claim 1 wherein said latching element is separate from said second component.

10. The automatic locking assembly of claim 1 wherein said latching element is integral to said second component.

11. An automatic window locking assembly, comprising:
a housing arranged for attachment to a first sash of a sliding window;
a cam at least partially disposed in said housing, said cam comprising a protrusion;
a latch element associated with a second sash of said window; and,
at least one resilient element arranged to urge said cam in a first rotational direction and in a first direction at least partially orthogonal to a plane formed between said first and second sashes, wherein when rotated to an unlocked position said cam is arranged so that said protrusion engages a portion of said latch element to prevent rotation of said cam in said first direction and to displace said cam in a second direction opposite said first direction, said displacement with respect to said first sash.

12. The assembly of claim 11 wherein in a locked position said cam is arranged to displace in said first direction, said displacement with respect to said first sash.

13. The assembly of claim 11 wherein in said locked position, said cam and said at least one resilient element are in rotational equilibrium.

14. The assembly of claim 11 wherein when at least one of said first and second sashes is moved from an open position to a closed position, said protrusion is arranged to contact said latch element and displace in said second direction, said displacement with respect to said first sash.

15. The assembly of claim 14 wherein said displacement in said second direction enables further movement of said at least one of said first and second sashes.

16. The assembly of claim 111 wherein said first and second sashes are tiltable with respect to said plane, said first sash further comprises at least one first tilt latch lock, and said cam is engaged with said first tilt latch lock.

17. The assembly of claim 11 wherein said at least one resilient element further comprises a first resilient element arranged to urge said cam in said first direction and a second resilient element arranged to urge said cam in said rotational direction.

18. The assembly of claim 17 wherein said first and second sashes are tiltable with respect to said plane, said first sash further comprises at least one second tilt latch lock including said second resilient element.

19. The assembly of claim 11 wherein said sliding window is selected from the group consisting of a double hung window, a single hung window, and a horizontally sliding window.

20. An automatic window locking assembly, comprising:
a rotatable cam arranged for at least indirect connection to a first sash of a sliding window, said cam comprising a protrusion;
a latch element associated with said second sash; and,
a resilient element arranged to urge said cam in a direction at least partially orthogonal to a plane formed between said first and second sashes, wherein when rotated to an unlocked position said cam is arranged to be displaced in a second direction, at least partially opposite said first direction, by contact between said protrusion and said latch element, wherein in a locked position said cam is arranged to be displaced in said first direction, and wherein said displacement in said first and second directions is with respect to said first sash.

21. An automatic window locking assembly, comprising:
a cam arranged for at least indirect connection to a first sash of a sliding window, said cam comprising a protrusion;
a latch element associated with said second sash;
a first resilient element arranged to urge said cam in a rotational direction; and,
a second resilient element arranged to urge said cam in a first direction at least partially orthogonal to a plane formed between said first and second sashes, wherein when rotated to an unlocked position said protrusion is arranged to engage a portion of said latch element to prevent rotation of said cam in said rotational direction and to displace said cam in a second direction at least partially opposite said first direction, wherein in a locked position said cam is arranged to displace in said first direction, and wherein said displacement in said first and second directions is with respect to said first sash.

22. An automatic locking assembly and sliding access control device, comprising:
a rotatable cam at least indirectly connected to a first component of said sliding access control device, said cam comprising a protrusion;
a latch assembly associated with said second component; and,
at least one resilient element arranged to urge said cam in a first direction at least partially orthogonal to a plane formed between said first and second components and to urge said cam in a rotational direction, wherein in a locked position, said cam is displaced in said first direction so that said protrusion engages said latch assembly, wherein when rotated to an unlocked position said protrusion is engaged with a first portion of said latch element to displace said cam in a second direction at least partially opposite said first direction, wherein in said unlocked position said protrusion is engaged with a second portion of said latch element to prevent rotation in said rotational direction, and wherein said displacement in said first and second directions is with respect to said first component.

23. An automatic locking assembly, comprising:
a rotatable cam arranged to at least indirectly connect to a first component of a sliding access control device, said cam comprising a protrusion;
a latch element associated with said second component; and,
at least one resilient element arranged to urge said cam in a rotational direction, wherein when rotated to an unlocked position said cam is arranged so that said protrusion engages a portion of said latch element to prevent rotation of said cam in said first direction.
